(19) United States
(12) Patent Application Publication
(10) Pub. No.: US 2015/0219047 A1
(43) Pub. Date: Aug. 6, 2015

(54) FILTER CLEANING ASSEMBLY

(71) Applicant: Shawn E. Peterson, Woonsocket, SD (US)

(72) Inventor: Shawn E. Peterson, Woonsocket, SD (US)

(21) Appl. No.: 14/589,605

(22) Filed: Jan. 5, 2015

Related U.S. Application Data
(60) Provisional application No. 61/923,429, filed on Jan. 3, 2014.

(51) Int. Cl. F02M 35/08; B01D 46/00

(52) U.S. Cl. CPC F02M 35/086; B01D 46/0068

(57) ABSTRACT

An air filter cleaner assembly having a graduated sealing disk, an air conduit having a shut-off valve and a quick connect male fitting on one end, and a cleaning head assembly on the other end. The cleaning head assembly enables air to flow from the interior of the air conduit to the exterior via a rotating sleeve, quick connectors, and nozzles. Various length nozzles can be interchanged on the rotating sleeve using the quick connectors, thereby enabling compressed air to be delivered in close proximity to the interior surface of an air filter being cleaned.

### RELATED APPLICATIONS

This application claims the benefit of U.S. Provisional Patent Application No. 61/923,429, filed Jan. 3, 2014, said application being hereby fully incorporated herein by reference.

### TECHNICAL FIELD

The embodiments of the invention are directed to a filter cleaning assembly for cleaning air filters. Specifically, the embodiments of the invention are directed to a filter cleaning assembly for cleaning cylindrical filters and radial seal air filters using pressurized air and a cleaning head with nozzles mounted on a rotating nozzle.

### BACKGROUND

Equipment with internal combustion engines is used in various industries such as farming, mining, construction, transportation, and in dirt and dust producing environments such as welding, powder coating, and fiberglass, wood, and paper industries. The equipment can be stationary or mobile but the common denominator is that air is brought into the engine to mix with the fuel for the combustion process. Ambient air enters the engine through an air filter that is provided to filter out dust, dirt and other contaminants. As the air filter traps the dust, dirt and other contaminants, the pores within the filter become clogged and air does not flow through the filter as freely and “dirty” air is also more likely to be provided to the engine. This results in poor performance of the engine as well as increased consumption of fuel, and if dirt passes through into the engine, increased engine wear and damage.

In order to increase the air flow, the air filter is often replaced with a brand new clean filter or the dirty filter is cleaned, either using compressed air or even, in some instances, chemicals. An issue with replacement is that many of the filters used in heavy duty equipment are expensive and large. Thus, replacement not only results in higher operating costs due to the cost in replacing the filter, but disposal of the filter is not eco-friendly. Current cleaning systems, using compressed air or chemicals, do not sufficiently clean the filters thus resulting in excessive cleaning activities which can be timely and costly. In addition, more fuel is used as the semi-clean filter is not allowing free air flow to the engine. It is known that during harvest season, a filter installed on a tractor or combine can need to be cleaned and/or replaced at least three times per an eight hour period. Neglecting to properly clean or not cleaning the air filter can result in the use of additional five gallons of fuel per hour.

It is well known for such filters to be cleaned with a nozzle attached to a source of compressed air, with a blast of air from the nozzle being applied to the inner surface of the filter. Such techniques, however, often result in a damaging rate of air flow being applied to localized areas on the filter, thereby blowing holes in the filter media and compromising the filtering characteristics of the media.

There have been attempts at producing an air filter cleaner using compressed air and a rotating element so as to reduce the direct impact of air on localized areas of the filter. For example, U.S. Pat. No. 6,588,057 to McMahon discloses an air filter cleaner having a rotating head that directs jets of air outwardly from the rotating head in order to clean a cylindrical air filter. U.S. Pat. No. 7,815,701 to Grieve discloses an apparatus for cleaning an air filter wherein jets of air from a rotating pipe member placed inside an air filter are directed onto the inside surface of the air filter. U.S. Patent Publication No. US2013/0037061 to Grieve discloses an apparatus for cleaning an air filter, wherein a head rotated by a system of internal baffles and orifices directs air onto the interior surface of an air filter through nozzles connected to the rotating head. All of these attempts, however, have various drawbacks, and none have fully addressed the need in the industry for a simple, durable, and effective air filter cleaner that is easy to use in the field.

### SUMMARY

An air filter cleaner assembly, according to an embodiment of the present invention, can include a graduated sealing disk to accommodate differing diameters of air filters, an air conduit having a shut-off valve and a quick connect male fitting on one end, and a cleaning head with nozzles coupled to a rotating sleeve on the other end. The cleaning head enables air to flow from the interior of the air conduit to the exterior via the rotating sleeve, connectors, and nozzles. Various length nozzles can be interchanged on the rotating sleeve using quick-connect pneumatic fittings so as to accommodate placing the air filter discharge in relatively close proximity to the interior surface of cylindrical air filters of varying internal diameters.

In an embodiment, the air filter cleaner assembly safely cleans air filters using pressurized air, without damaging the air filter, thus effectively extending the life of the filter. The air filter cleaner is portable, lightweight, durable, and easy to use. The air filter cleaner is able to be used on multiple sizes and styles of radial seal filters as well as other types and styles of cylindrical filters, including filters for, but not limited to, combustion engines, electrical motors, dust collection units, and vacuums.

The air filter cleaner system can be used with pressurized air provided from an ordinary shop-style air compressor or portable air compressor. Nozzles can be provided in various lengths and are interchangeable thus allowing the user to alter the configuration on the rotating sleeve to coincide with the size of filter being cleaned. The graduated sealing disk is configured so that the graduating disk layers coincide with the inside diameter of the most common size air filters on the market.

An air filter cleaner assembly according to an embodiment of the invention includes an elongate air conduit, and a sealing disk adapted to engage with an end of a cylindrical air filter, the sealing disk defining an aperture, with the elongate air conduit being slidingly received in the aperture. The apparatus further includes a cleaning head assembly disposed at a distal end of the elongate air conduit. The cleaning head assembly includes a shaft member having a head portion and a shaft portion, the shaft member defining a longitudinal bore, the shaft portion defining a plurality of air ports extending from the longitudinal bore to an outer surface of the shaft portion. The cleaning head assembly further includes a connecting sleeve coupling the shaft member to the elongate air conduit, and a rotating member rotatably mounted on the shaft portion between the head and the connecting sleeve, the rotating member including a bearing portion defining a plurality of apertures vertically registered with the air ports of the shaft portion, and a first plurality of nozzles, each of the first plurality of nozzles being coupled to a separate one of the apertures in the bearing portion with a separate quick-connect pneumatic fitting such that the nozzles are attachable and detachable from the bearing portion by operation of the quick-connect pneumatic fittings, the nozzles being oriented tangentially relative to the bearing portion and fluidly coupled with the air conduit, such that compressed air supplied through the air conduit, longitudinal bore, air ports, and quick-connect pneumatic fittings causes air to be expelled from the nozzles, thereby causing rotation of the rotating member on the shaft portion.

In embodiments of the invention, the sealing disk may have a plurality of disk levels, each disk level having a different diameter. In other embodiments, the quick-connect pneumatic fittings are elbows. The elbows may have an elbow angle of 90 degrees or 135 degrees. In other embodiments, the quick-connect pneumatic fittings are straight fittings.

The rotating member may have three apertures, the apertures equally radially spaced apart by 120 degrees. The shaft member may have four air ports, the air ports equally radially spaced apart by 90 degrees.

In embodiments of the invention the bearing portion is made from acetal homopolymer resin, and the connecting sleeve and shaft member are made from heat treated stainless steel.

In other embodiments, the air filter cleaner assembly may further include a second plurality of nozzles, the first plurality of nozzles having a first length dimension, the second plurality of nozzles having a second length dimension greater than the first length dimension, the second plurality of nozzles being interchangeable with the first plurality of nozzles. The assembly may further include a spare nozzle holder operably coupled to the sealing disk, the spare nozzle holder adapted to receive at least one of the first plurality of nozzles or the second plurality of nozzles.

According to an embodiment of the invention, a cleaning head for an air filter cleaner includes a shaft member having a head portion and a cylindrical shaft portion extending from the head portion, the shaft member defining an internal cavity and a plurality of ports extending from the internal cavity to an outer surface of the shaft portion. A generally cylindrical sleeve is rotatably mounted on the shaft portion. The cleaning head further includes a plurality of straight nozzles, each nozzle operably coupled to the sleeve though a pneumatic quick-connect fitting, the nozzles oriented tangentially relative to the sleeve, the nozzles being in fluid communication with the internal cavity of the shaft member through the plurality of ports and the pneumatic quick-connect fittings.

The shaft member may have four ports radially spaced apart at 90 degree intervals. The pneumatic quick-connect fittings may be elbows, and the elbows may have an elbow angle of 90 degrees. The sleeve may have a plurality of apertures, each aperture receiving a separate one of the pneumatic quick-connect fittings. The apertures may be radially spaced apart by 120 degrees.

In an embodiment, an air filter cleaner assembly includes an elongate air conduit, a sealing disk adapted to engage with an end of a cylindrical air filter, the sealing disk defining an aperture, the elongate air conduit being slidingly received in the aperture, and a cleaning head assembly disposed at a distal end of the elongate air conduit. The cleaning head assembly includes a shaft member having a head portion and a cylindrical shaft portion extending from the head portion, the shaft member defining an internal cavity and a plurality of ports extending from the internal cavity to an outer surface of the shaft portion, a generally cylindrical sleeve rotatably mounted on the shaft portion, and a plurality of straight nozzles, each nozzle operably coupled to the sleeve though a pneumatic quick-connect fitting, the nozzles oriented tangentially relative to the sleeve, the nozzles being in fluid communication with the internal cavity of the shaft member through the plurality of ports and the pneumatic quick-connect fittings.

The above summary of the various representative embodiments of the invention is not intended to describe each illustrated embodiment or every implementation of the invention. Rather, the embodiments are chosen and described so that others skilled in the art can appreciate and understand the principles and practices of the invention. The figures in the detailed description that follow more particularly exemplify these embodiments.

### BRIEF DESCRIPTION OF THE DRAWINGS

The embodiments of the invention can be completely understood in consideration of the following detailed description of various embodiments of the invention in connection with the accompanying drawings, in which:

FIG. 1 is a perspective view of an air filter cleaner assembly according to an embodiment;

FIG. 2 is a top perspective view of a graduated sealing disk having an air conduit centrally disposed in the disk;

FIG. 3 is a side elevation view of a shut-off valve and a quick connect male fitting disposed on one end of the air conduit;

FIG. 4 is a side perspective view of the cleaning head of the air filter cleaner assembly of FIG. 1;

FIG. 5 is a bottom plan view of the cleaning head of FIG. 4 without attached nozzles;

FIG. 6 is a top plan view of the cleaning head of FIG. 4;

FIG. 7 is a bottom plan view of the cleaning head of FIG. 4;

FIG. 8 is a disassembled view of a cleaning head depicting the shaft member, connecting sleeve, and rotating member;

FIG. 9 is a side plan view of an arm according to an embodiment;

FIG. 10 is an end view of an arm according to an embodiment;

FIG. 11 depicts an air filter cleaner according to an embodiment of the invention with an air filter;

FIG. 12 depicts a partial, inverted, vertical cross-section taken at section 12-12 of FIG. 4;

FIG. 13 depicts a partial, horizontal cross-section taken at section 13-13 of FIG. 4; and

FIG. 14 depicts a partial, horizontal cross-section taken at section 13-13 of FIG. 4 for an alternative embodiment in which the radial arms of the rotating head are disposed directly tangentially to the rotating head of the apparatus.

While the embodiments of the invention are amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

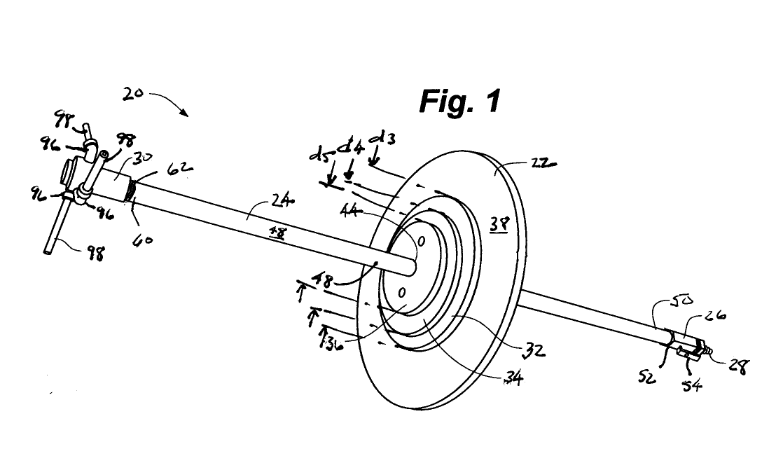

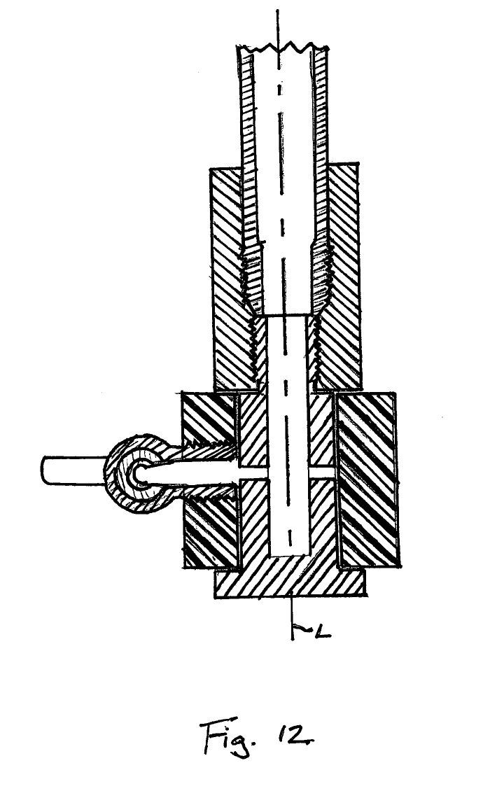

FIG. 1 depicts an air filter cleaner assembly 20 according to an embodiment. Air filter cleaner assembly 20 generally includes graduated sealing disk 22, air conduit 24 with shut-off valve 26, quick connect male plug 28, and cleaning head assembly 30. Graduated sealing disk 22 generally includes various disk levels 32, 34, 36 disposed on underside 38 of graduated sealing disk 22. As depicted in FIG. 11, disk levels 32, 34, 36 can be sized to coincide with the inner diameter (d) of a cylindrical air filter 40 so that the appropriately sized disk level 32, 34, 36 is snugly mated to an end 42 of filter 40, thus limiting any lateral movement of air filter cleaner assembly 20 relative to the filter 40. It is understood that while three disk levels 32, 34, 36 are depicted, there can be more or fewer disk levels provided. In an embodiment, a pyramidal shape can be provided on underside 38 of sealing disk 22 to provide varying sealing circumferences. Sealing disk 22 and disk levels 32, 34, 36 define centrally located apertures 44, registered with each other, and that are sized to receive air conduit 24. Inwardly facing surface (not shown) 46 defining apertures 44 and outer surface 48 of air conduit 24 can be closely mated to enable longitudinal sliding movement of air conduit 24 in apertures 44 while still inhibiting excessive air leakage between air conduit 24 and surface 46. In an embodiment, a silicone seal or other type of sealing arrangement can be provided between apertures 44 and air conduit 24. It should be understood, however, that any type of sealing arrangement between air conduit 24 and apertures 44 can be used that is suitable for inhibiting leakage while also enabling air conduit 24 to be freely slid longitudinally relative to sealing disk 22.

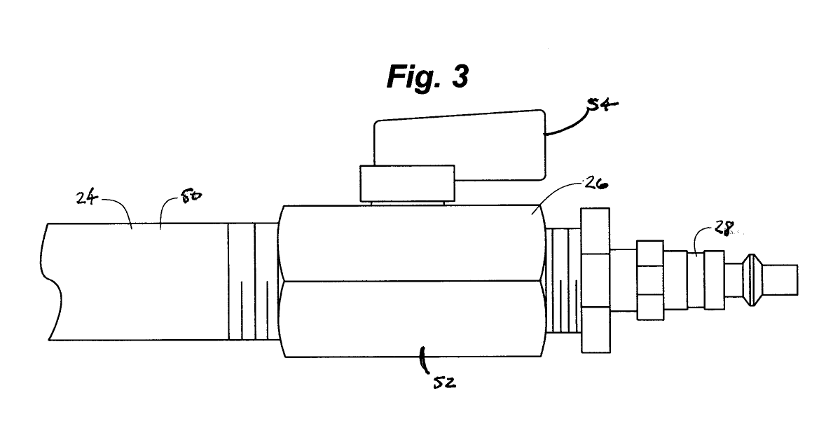

In the embodiment depicted in FIGS. 1-3, proximal end 50 of air conduit 24 is coupled to shut-off valve 26 which is, in turn, coupled to quick connect male plug 28. Shut-off valve 26 generally includes valve body 52 and valve handle 54, can be any kind of shut-off valve that is known to those with skill in the art, including, but not limited to, lever, wheel, ball, compression, etc. Quick connect male plug 28 is adapted to matingly attach to a standard quick connect female coupling 56 as is commonly used on air hose 58. Distal end 60 of air conduit 24 defines external threads 62.

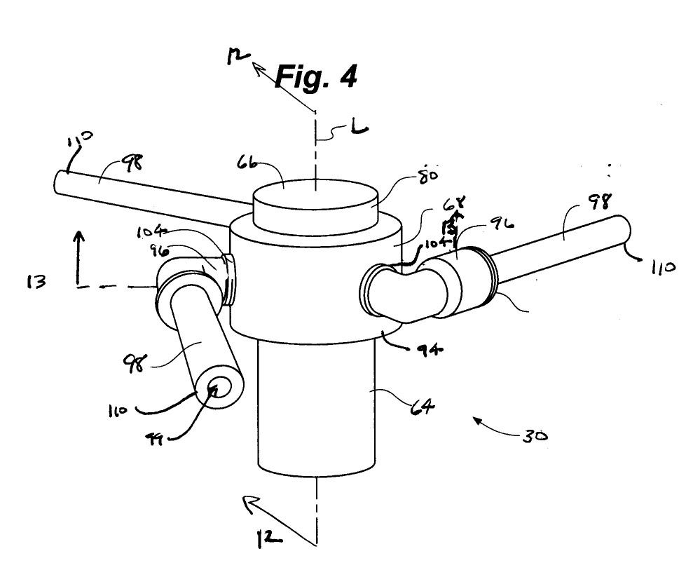

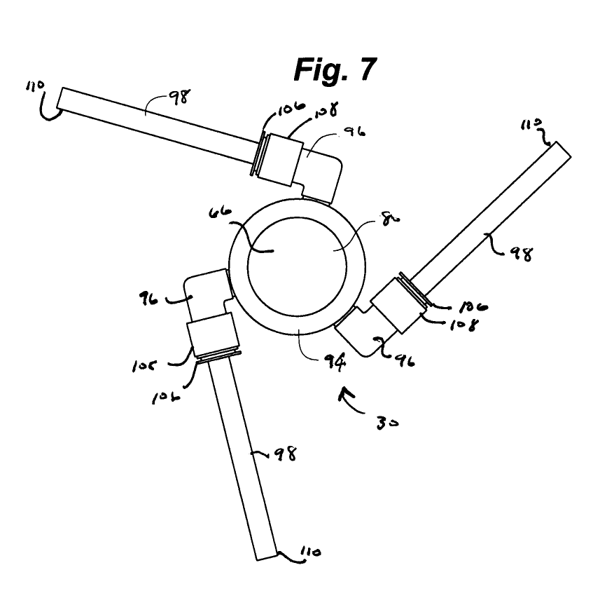

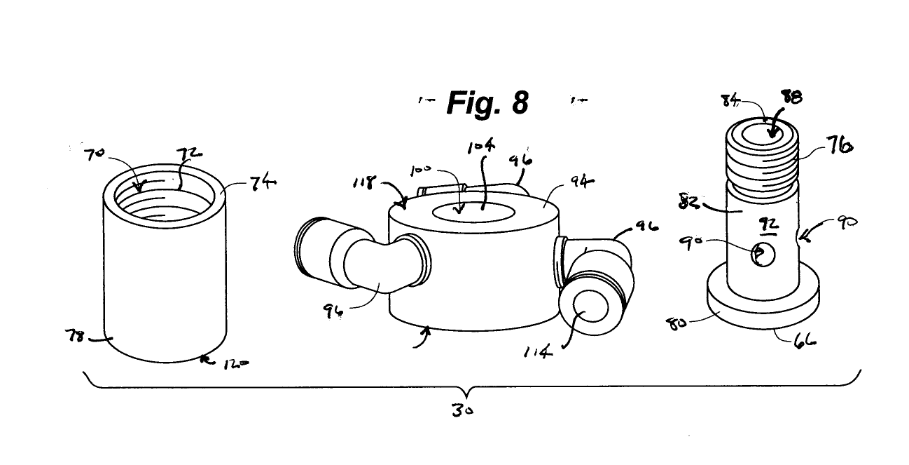

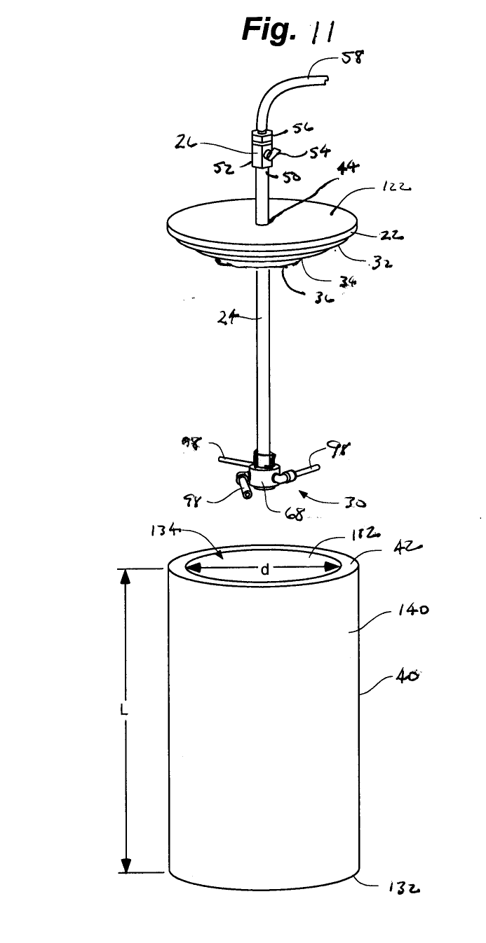

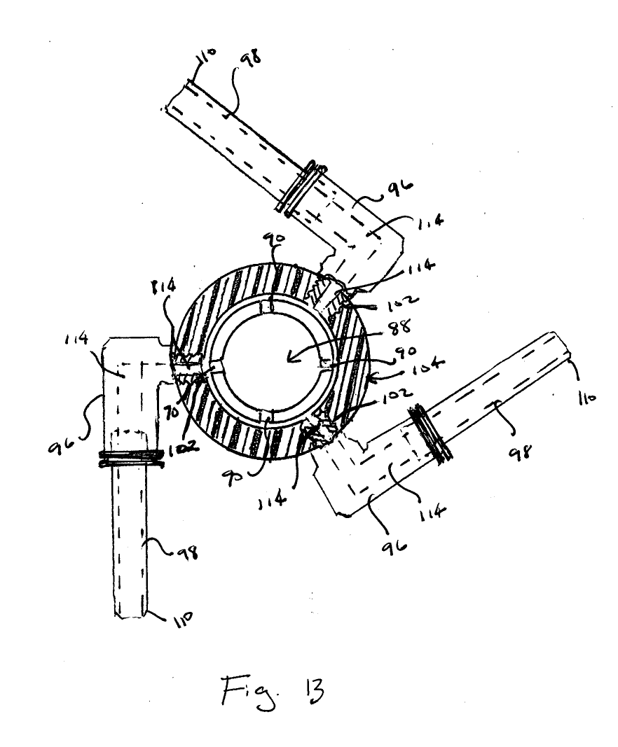

FIGS. 4-12 depict an embodiment of cleaning head assembly 30. Cleaning head assembly 30 generally includes connecting sleeve 64, shaft member 66, and rotating member 68. Connecting sleeve 64 defines bore 70 with internal threads 72 facing proximal end 74, and internal threads 76 facing distal end 78. Internal threads 72 receive external threads 62 of air conduit 24 so that connecting sleeve 64 is rotationally and longitudinally fixed to air conduit 24. In an embodiment, connecting sleeve 64 is made from heat treated stainless steel. In other embodiments, connecting sleeve may be made from other metals such as brass, or polymer materials.

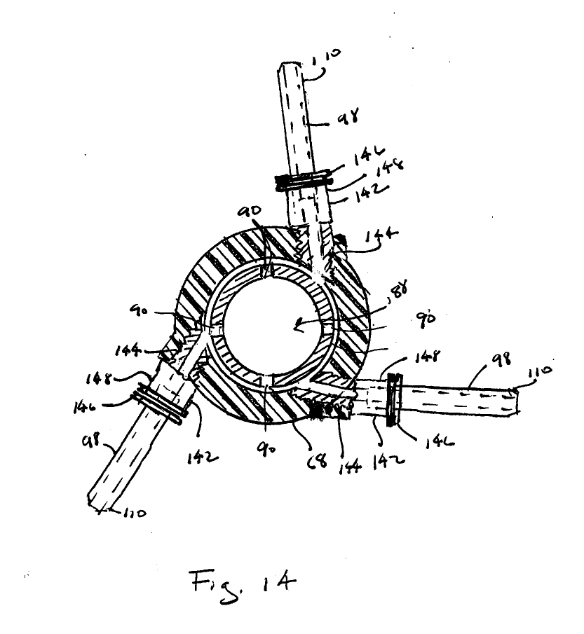

Shaft member 66 generally includes head portion 80, and shaft portion 82. Shaft portion 82 presents proximal end 84 defining external threads 86. An internal cavity in the form of longitudinal bore 88 extends from proximal end 84 to proximate head portion 80. Air ports 90 extend from longitudinal bore 88 through to shaft outer surface 92. As depicted in FIG. 13, shaft portion 82 may have four air ports 90, equally spaced radially at 90 degrees from each other. It will of course be appreciated that more or fewer air ports 90 may be provided within the scope of the invention. Shaft member 66 may be made from heat treated stainless steel or other suitable metal, or from polymer material. External threads 86 engage with internal threads 76 of connecting sleeve 64 so that shaft member 66 is longitudinally and rotationally fixed to connecting sleeve 64 and air conduit 24.

Rotating member 68 generally includes bearing portion 94, elbows 96, and interchangeable nozzles 98. Bearing portion 94 defines bore 100 with apertures 102 extending through from bore 100 to outer surface 104. As depicted in FIG. 13, bearing portion 94 may have three apertures 102 equally spaced radially at 120 degrees from each other. It will of course be appreciated that more or fewer apertures 102 may be provided within the scope of the invention. In an embodiment, bearing portion 94 may be formed from acetal homopolymer resin (Delrin®) or other polyoxymethylene (POM) polymer material. In another embodiment, rotating bearing portion 94 can be made from metal such as brass or steel. In another embodiment, bearing portion 94 can be formed from other lubricious and durable plastic materials such as PTFE, other fluoropolymer, or polyurethane blends. The lubricious qualities of acetal homopolymer resin, polyoxymethylene (POM) polymer material, PTFE, other fluoropolymer, or polyurethane blends may help reduce friction between bearing portion 94 and shaft portion 82 and aid in free rotation of rotating member 68.

Elbows 96 may be standard quick connect pneumatic fittings with external threads on proximal end 104 and push-in tubing quick-connector 106 at distal end 108. Proximal end 104 of each elbow 96 is threaded into a separate one of apertures 102. Each of nozzles 98 is received in a separate one of push-in tubing quick-connectors 106. Nozzles 98 define air passage 99. Nozzles 98 may be straight lengths of rigid aluminum tubing, or other rigid metallic or polymer tubing, having an outer diameter at end 107 suitable to be received in push-in tubing quick-connectors 106.

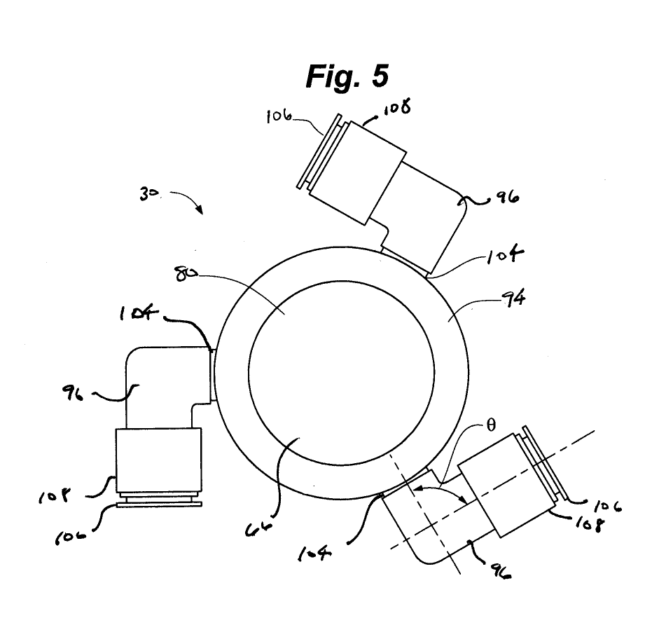

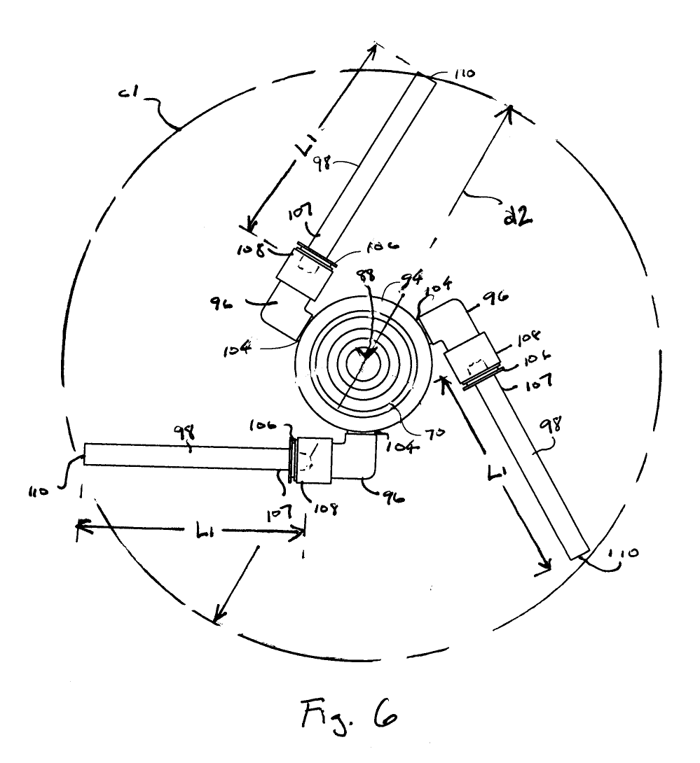

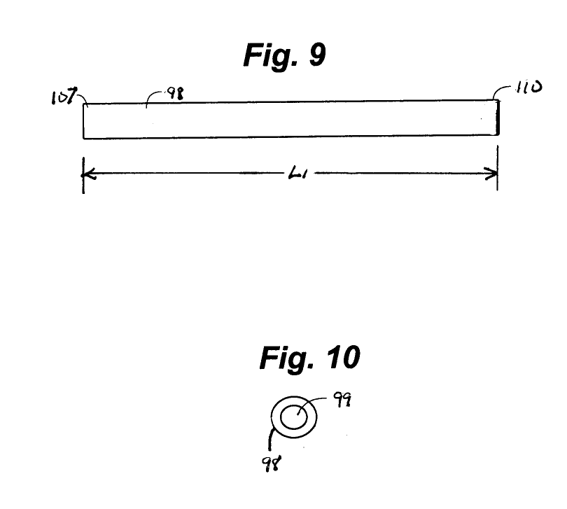

It will be appreciated that the length L1 of nozzles 98 may be selected so as to enable end 110 of nozzles 98 to be located proximate inner surface 112 of filter 40. Advantageously, as depicted in FIGS. 6 and 9, length L1 of nozzles 98 can be selected such that the diameter d2 of a circle c1 circumscribed around the ends 110 of nozzles 98 is just less than the diameter d3, d4, or d5, of a respective one of disk levels 32, 34, 36, thus preventing the nozzles 98 from contacting inner surface 112 during rotation of rotating member 68. It will be appreciated that elbow angle θ as depicted in FIG. 5, may be 90 degrees as depicted in the embodiment of FIGS. 1-13, or another suitable angle greater than zero and less than 180 degrees, such as 135 degrees.

As depicted in FIGS. 4, 6, and 12-14, shaft portion 82 of shaft member 66 is received through bore 100. The clearance between shaft outer surface 92 and wall 104 defining bore 100 is just sufficient such that rotating member 68 is freely rotatable on shaft portion 82. In some embodiments, these components may be at least separated by a thin layer of air in operation, thereby achieving a partially aerodynamic lubrication arrangement between the components. Air passages 114 of elbows 96 are vertically registered with air ports 90 of shaft member 66 with bottom wall 116 of bearing portion 94 abutting head portion 80. Top wall 118 of bearing portion 94 abuts lower surface 120 of connecting sleeve 64 so that rotating member 68 is retained on shaft portion 82 with minimal vertical movement.

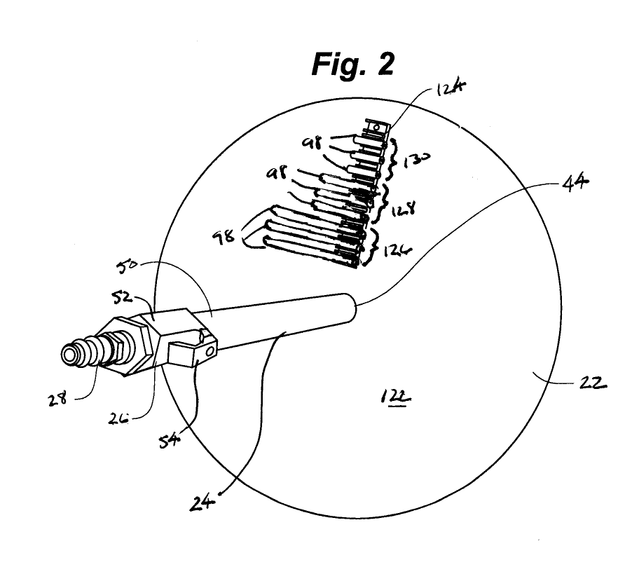

In an embodiment depicted in FIG. 2, top side 122 of sealing disk 22 can be provided with spare nozzle retaining device 124. Nozzles 98 having various lengths may be stored in spare nozzle retaining device 124, thus providing the benefit of easy access and retention of additional nozzles 124 for easy substitution. As set forth above, nozzles 98 may have lengths L1 such that the diameter d2 of a circle circumscribed around the ends 110 of nozzles 98 is just less than the diameter d3, d4, d5, of a respective one of disk levels 32, 34, 36. Nozzle sets 126, 128, 130, may be assembled with nozzle 98 lengths thus corresponding respectively with disk levels 32, 34, 36.

In operation, as depicted in FIG. 11, filter 40 is removed from the engine, or other equipment requiring clean air flow, with end 132 placed on a flat surface such as the ground so that air filter channel 134 is orthogonal to the surface. Nozzles 98 of a suitable length L1 are chosen based on the air filter channel inner diameter (d) and attached to elbows 96. It will be appreciated that the length L1 of nozzles 98 is chosen so that the ends 110 do not contact the inner surface 112 of filter 40, enabling free rotation of rotating member 68. Conveniently, one of nozzle sets 126, 128, 130, may be selected based on which of disk levels 32, 34, 36, is engaged by the filter 40. Air conduit 24 extends through apertures 44 of sealing disk 22 so that cleaning head assembly 30 is disposed inside air filter channel 134. Sealing disk 22 is abutted with end 42 of filter 40 so that the appropriate disk level 32, 34, 36, matingly engages with end 42. Air hose 58 is coupled with a source of compressed air, and is coupled to air conduit 24 through quick connect male plug 28 and quick connect female coupling 56. Compressed air is admitted to air conduit 24 by opening shut-off valve 26. As compressed air flows through air conduit 24, the air passes through longitudinal bore 88 of shaft member 66, through air ports 90 in shaft member 66, and air passages 114 of elbows 96, and is expelled from ends 110 of nozzles 98. Since nozzles 98 are oriented tangentially to bearing portion 94 by virtue of elbow angle θ, the jets of air escaping from ends 110 cause rotating member 68 to rotate on shaft portion 82. With sufficient air pressure, rotating member 68 will rotate at a high speed. The jets of air impinge upon the inner surface 112 of filter 40 and blow dirt and particles from the outer surface 140 of filter 40. As the rotating member 68 is rotating, the user manually slides the air conduit 24 up and down, with aperture 44 as a guide, so as to traverse the entire length (L) of air filter channel 134. Once filter 40 is sufficiently clean, shut-off valve 26 can be closed, air filter cleaner assembly 20 removed from filter 40, and filter 40 replaced in the equipment.

It will be appreciated that with air ports 90 radially spaced at 90 degree intervals and air passages 114 radially spaced at 120 degree intervals as depicted in FIG. 13, the compressed air is directly connected to only one of nozzles 98 at a time as bearing portion 94 rotates. With a sufficiently high rotational speed, however, a substantially continuous flow of air will escape from the ends 110 of nozzles 98, if at a somewhat reduced pressure. This reduced pressure may advantageously reduce any tendency of the jets of air to blow holes in the media of filter 40.

In an alternative embodiment depicted in FIG. 14, straight fittings 142 connected at a tangential angle to bearing portion 94, and supplied with nozzles 98, can provide a similar rotating and filter cleaning function. As depicted, straight fittings 142 may be may be standard quick connect pneumatic fittings with external threads on proximal end 144 and push-in tubing quick-connector 146 at distal end 148.

Although air filter cleaner assembly 20 is useful to clean air filters for internal combustion engines, it will be appreciated that the device can also be used to clean air filters used for any other purpose as well.

While the invention is amenable to various modifications and alternative forms, specifics thereof have been shown by way of example in the drawings and described in detail. It is understood, however, that the intention is not to limit the invention to the particular embodiments described. On the contrary, the intention is to cover all modifications, equivalents, and alternatives falling within the spirit and scope of the invention as defined by the appended claims.

What is claimed is:

1. An air filter cleaner assembly comprising:
an elongate air conduit;
a sealing disk adapted to engage with an end of a cylindrical air filter, the sealing disk defining an aperture, the elongate air conduit being slidingly received in the aperture;
a cleaning head assembly disposed at a distal end of the elongate air conduit, the cleaning head assembly comprising:
a shaft member having a head portion and a shaft portion, the shaft member defining a longitudinal bore, the shaft portion defining a plurality of air ports extending from the longitudinal bore to an outer surface of the shaft portion;
a connecting sleeve coupling the shaft member to the elongate air conduit; and
a rotating member rotatably mounted on the shaft portion between the head and the connecting sleeve, the rotating member including a bearing portion defining a plurality of apertures vertically registered with the air ports of the shaft portion, and a first plurality of nozzles, each of the first plurality of nozzles being coupled to a separate one of the apertures in the bearing portion with a separate quick-connect pneumatic fitting such that the nozzles are attachable and detachable from the bearing portion by operation of the quick-connect pneumatic fittings, the nozzles being oriented tangentially relative to the bearing portion and fluidly coupled with the air conduit, such that compressed air supplied through the air conduit, longitudinal bore, air ports, and quick-connect pneumatic fittings causes air to be expelled from the nozzles, thereby causing rotation of the rotating member on the shaft portion.

2. The air filter cleaner assembly of claim 1, wherein the sealing disk has a plurality of disk levels, each disk level having a different diameter.

3. The air filter cleaner assembly of claim 1, wherein the quick-connect pneumatic fittings are elbows.

4. The air filter cleaner assembly of claim 3, wherein the elbows have an elbow angle of 90 degrees.

5. The air filter cleaner assembly of claim 3, wherein the elbows have an elbow angle of 135 degrees.

6. The air filter cleaner assembly of claim 1, wherein the quick-connect pneumatic fittings are straight fittings.

7. The air filter cleaner assembly of claim 1, wherein the rotating member has three apertures, the apertures equally radially spaced apart by 120 degrees.

8. The air filter cleaner assembly of claim 1, wherein the shaft member has four air ports, the air ports equally radially spaced apart by 90 degrees.

9. The air filter cleaner assembly of claim 1, wherein the bearing portion is made from acetal homopolymer resin, and the connecting sleeve and shaft member are made from heat treated stainless steel.

10. The air filter cleaner assembly of claim 1, wherein the nozzles are straight.

11. The air filter cleaner assembly of claim 1, further comprising a second plurality of nozzles, the first plurality of nozzles having a first length dimension, the second plurality of nozzles having a second length dimension greater than the first length dimension, the second plurality of nozzles being interchangeable with the first plurality of nozzles.

12. The air filter cleaner assembly of claim 11, further comprising a spare nozzle holder operably coupled to the sealing disk, the spare nozzle holder adapted to receive at least one of the first plurality of nozzles or the second plurality of nozzles.

13. A cleaning head for an air filter cleaner, the cleaning head comprising:
a shaft member having a head portion and a cylindrical shaft portion extending from the head portion, the shaft member defining an internal cavity and a plurality of ports extending from the internal cavity to an outer surface of the shaft portion;
a generally cylindrical sleeve rotatably mounted on the shaft portion;
a plurality of straight nozzles, each nozzle operably coupled to the sleeve though a pneumatic quick-connect fitting, the nozzles oriented tangentially relative to the sleeve, the nozzles being in fluid communication with the internal cavity of the shaft member through the plurality of ports and the pneumatic quick-connect fittings.

14. The cleaning head of claim 13, wherein the shaft member has four ports radially spaced apart at 90 degree intervals.

15. The cleaning head of claim 13, wherein the pneumatic quick-connect fittings are elbows.

16. The cleaning head of claim 15, wherein the elbows have an elbow angle of 90 degrees.

17. The cleaning head of claim 13, wherein the sleeve has a plurality of apertures, each aperture receiving a separate one of the pneumatic quick-connect fittings.

18. The cleaning head of claim 17, wherein the apertures are radially spaced apart by 120 degrees.

19. An air filter cleaner assembly comprising:
an elongate air conduit;
a sealing disk adapted to engage with an end of a cylindrical air filter, the sealing disk defining an aperture, the elongate air conduit being slidingly received in the aperture;
a cleaning head assembly disposed at a distal end of the elongate air conduit, the cleaning head assembly comprising:
a shaft member having a head portion and a cylindrical shaft portion extending from the head portion, the shaft member defining an internal cavity and a plurality of ports extending from the internal cavity to an outer surface of the shaft portion;
a generally cylindrical sleeve rotatably mounted on the shaft portion;
a plurality of straight nozzles, each nozzle operably coupled to the sleeve though a pneumatic quick-connect fitting, the nozzles oriented tangentially relative to the sleeve, the nozzles being in fluid communication with the internal cavity of the shaft member through the plurality of ports and the pneumatic quick-connect fittings.

20. The air filter cleaning assembly of claim 19, wherein the pneumatic quick-connect fittings are elbows.
